(19) United States
(12) Patent Application Publication
(10) Pub. No.: US 2026/0290656 A1
(43) Pub. Date: Sep. 24, 2026

(54) WIRING MEMBER

(71) Applicant: SUMITOMO WIRING SYSTEMS, LTD., Yokkaichi-shi (JP)

(72) Inventors: Hidetsugu KUBOTA, Yokkaichi-shi (JP); Taiki SHIKATA, Yokkaichi-shi (JP); Hikaru NISHIO, Yokkaichi-shi (JP); Yukitoshi TERASAKA, Yokkaichi-shi (JP)

(73) Assignee: SUMITOMO WIRING SYSTEMS, LTD., Yokkaichi-shi (JP)

(21) Appl. No.: 19/571,787

(22) Filed: Mar. 19, 2026

(30) Foreign Application Priority Data
Mar. 20, 2025 (JP) 2025-046115

(51) Int. Cl. H01B 17/58; H01B 7/18

(52) U.S. Cl. CPC H01B 17/583; H01B 7/184

(57) ABSTRACT

Provided is a wiring member that is able to suppress the occurrence of sticky mold and is capable of achieving an improvement in productivity. A wiring member includes a wire and a molded part covering the outer peripheral surface of the wire. A parting line is provided at two positions on the outer peripheral surface of the molded part. If the molded part is divided in a virtual manner into a first part and a second part, via a virtual plane including the parting lines located at two positions, the first part does not have an undercut shape with respect to a release direction orthogonal to the virtual plane, and the second part has an undercut shape with respect to the release direction.

### CROSS-REFERENCE TO RELATED APPLICATIONS

This application claims priority of Japanese Patent Application No. JP2025-046115 filed on Mar. 20, 2025, the contents of which are incorporated herein.

### TECHNICAL FIELD

The present disclosure relates to a wiring member.

### BACKGROUND

JP 2024-31506A discloses a wiring harness serving as a wiring member provided with a wire and a molded resin member that cover an outer peripheral surface of the wire. This molded resin member is constituted as a grippable member that is gripped with a gripping part. The molded resin member has a cylindrical shape as a whole. The molded resin member is formed by injecting a molten resin material into a cavity formed between an upper mold and a lower mold.

JP 2024-31506A (FIG. 10) is an example of related art.

For example, when molding a molded article such as the above molded resin member with an upper mold and a lower mold that are openable and closeable, so-called “sticky mold”, which is a phenomenon where the molded article remains in the upper mold despite being designed to remain in the lower mold, may occur. When sticky mold occurs, removal of the molded article is extremely difficult, leading to deterioration in productivity, and thus countermeasures are required.

In view of the above, an object of the present disclosure is to provide a wiring member that is able to suppress the occurrence of sticky mold and is capable of achieving an improvement in productivity.

### SUMMARY

A wiring member of the present disclosure includes a wire and a molded part covering an outer peripheral surface of the wire, in which a parting line is provided at two positions on an outer peripheral surface of the molded part, and if the molded part is divided in a virtual manner into a first part and a second part, via a virtual plane including the parting lines located at two positions, the first part does not have an undercut shape with respect to a release direction orthogonal to the virtual plane, and the second part has an undercut shape with respect to the release direction.

According to the present disclosure, a wiring member that is able to suppress the occurrence of sticky mold and is capable of achieving an improvement in productivity can be provided.

### BRIEF DESCRIPTION OF THE DRAWINGS

FIG. 1 is a side view of a wiring member of a first embodiment;

FIG. 2 is a cross-sectional view taken along line I-I in FIG. 1 of the wiring member of the first embodiment;

FIG. 3 is a bottom view of a first mold that is used in manufacturing the wiring member of the first embodiment;

FIG. 4 is a side view of the wiring member of a second embodiment;

FIG. 5 is a cross-sectional view taken along line II-II in FIG. 4 of the wiring member of the second embodiment;

FIG. 6 is a side view of the wiring member of a third embodiment; and

FIG. 7 is a cross-sectional view taken along line III-III in FIG. 6 of the wiring member of the third embodiment.

### DETAILED DESCRIPTION OF PREFERRED EMBODIMENTS

First, modes of the present disclosure will be enumerated and described.

A wiring member of the present disclosure includes:
(1) a wire and a molded part covering an outer peripheral surface of the wire, in which a parting line is provided at two positions on an outer peripheral surface of the molded part, and if the molded part is divided in a virtual manner into a first part and a second part, via a virtual plane including the parting lines located at two positions, the first part does not have an undercut shape with respect to a release direction orthogonal to the virtual plane, and the second part has an undercut shape with respect to the release direction.

When forming the wiring member, a first mold corresponding to the first part and a second mold corresponding to the second part are used. Here, the molded article that will form the wiring member is required to remain in the second mold (mold from which it is planned to remove the molded article) and separate from the first mold, after the mold is opened. In this respect, according to the configuration of (1) above, the first part does not have an undercut shape with respect to the release direction and the second part has an undercut shape with respect to the release direction, and thus a state in which the first part separates from the first mold and the second part remains in the second mold can be formed with certainty. As a result, the wiring member formed as a molded article can be removed from the second mold without difficulty, and an improvement in productivity can be achieved.
(2) In the wiring member according to (1) above, preferably the undercut shape is constituted by a peripheral surface portion extending in a direction intersecting the release direction on an outer peripheral surface of the second part.

According to this configuration, the undercut shape can be formed without providing the second part with a special shape.
(3) In the wiring member according to (2) above, an outer peripheral shape of a cross-section of the molded part parallel to the release direction may be circular, and the outer peripheral surface of the second part may have a major arc shape including the peripheral surface portion and whose two circumferential ends are the parting lines located at two positions.

The outer peripheral surface of the second part does not include any special shape, and thus the wiring member has a broader application range and can be provided with versatility.
(4) In the wiring member according to (1) above, preferably the undercut shape is constituted by a protrusion protruding from an outer peripheral surface of the second part in a direction intersecting the release direction.

According to this configuration, release resistance during release of the second part can be set to an appropriate value, by adjusting the shape, protrusion dimension, angular position, and the like of the protrusion.
(5) In the wiring member according to (4) above, the protrusion may be disposed in close proximity to each of the parting lines.

According to this configuration, excessive release resistance during release of the second part can be avoided.
(6) In the wiring member according to (1) above, preferably the undercut shape is constituted by an undercut recess extending in a direction intersecting the release direction inside the second part and opening on an outer peripheral surface of the second part.

The undercut shape is provided on the inner side of the second part as an undercut recess, and thus the outer peripheral shape of the second part and, hence, the wiring member can be prevented from increasing in size.
(7) In the wiring member according to (6) above, the molded part may have a non-undercut recess extending in the release direction inside the first part and opening on an outer peripheral surface of the first part, and a bottom surface of each of the undercut recess and the non-undercut recess may be constituted by the outer peripheral surface of the wire.

When forming the wiring member, a pressing mold for pressing down the wire, which is an insert component, is used. A recess is formed in the molded part due to the extraction of the pressing mold. Here, recesses can be undercut recesses and non-undercut recesses. By utilizing the recesses formed due to the extraction of pressing molds as undercut recesses and non-undercut recesses, the undercut recesses and non-undercut recesses are obtained without requiring dedicated parts that merely constitute undercut shapes and non-undercut shapes.
(8) In the wiring member according to any one of (1) to (7) above, preferably the molded part is a grommet.

According to the above wiring member, infiltration of water or the like between the wire and the grommet can be suppressed, and thus the wiring member is suitably applicable in environments where, for example, waterproofness is required. By applying the wiring member to the wiring harness of an automobile, for example, an improvement in routing workability and usability can be achieved.

Specific examples of the present disclosure will be described below with reference to the drawings. Note that the present disclosure is not limited to these illustrative examples and is indicated by the claims, and all changes that come within the meaning and range of equivalency of the claims are intended to be embraced therein.

### FIRST EMBODIMENT

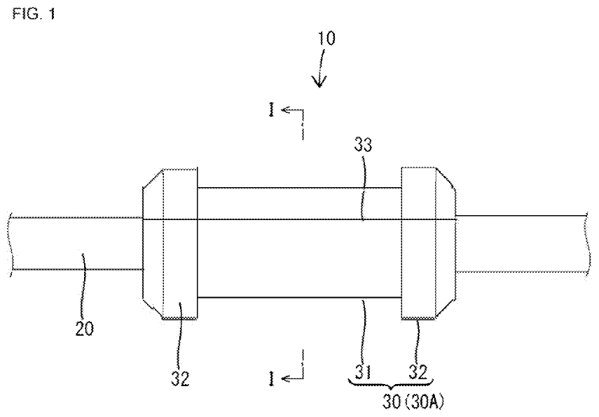

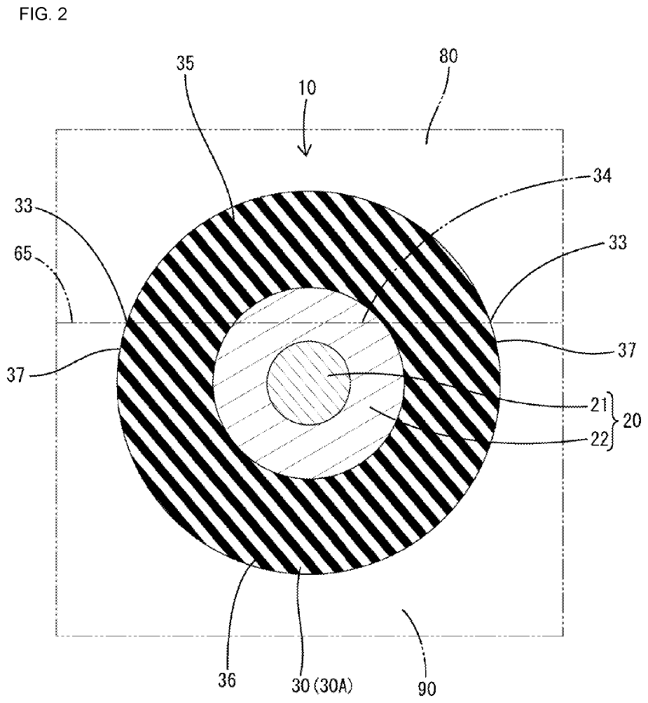

A wiring member 10 of a first embodiment of the present disclosure is constituted as, for example, a wiring harness that is routed in a vehicle. As shown in FIGS. 1 and 2, the wiring member 10 is provided with a wire 20 and a molded part 30 that covers the outer peripheral surface of the wire 20. In the case of this first embodiment, the wire 20 is a coated wire in which a conductor 21 consisting of a core wire is covered circumferentially with an insulating resin 22, as shown in FIG. 2. The insulating resin 22 is constituted by materials such as vinyl chloride and an olefin resin. The wire 20 is, for example, constituted such that an outer peripheral shape of a cross-section (hereinafter, “transverse section”) cut in a direction orthogonal to an axial direction is circular.

The molded part 30 is integrally provided by molding on the outer peripheral surface of the wire 20. By integrally providing the molded part 30 on the outer peripheral surface of the wire 20, a gap that can form between the molded part 30 and the wire 20 can be eliminated or reduced, making it possible to suppress infiltration of water or the like through the gap.

The molded part 30 is exemplified as a grommet 30A. The grommet 30A is constituted by a thermoplastic elastomer such as vinyl chloride, polyolefin, polyurethane, and the like, which are materials capable of being integrated with the wire 20. The grommet 30A is not particularly limited in shape, and, here, is constituted having a main body 31 that extends axially and a pair of wide diameter parts 32 that protrude radially outward from the two axial ends of the main body 31 around the entire circumference thereof, as shown in FIGS. 1 and 2. The main body 31 covers an axially intermediate portion of the wire 20. The transverse sections of the main body 31 and the wide diameter parts 32 both have a circular shape, and, specifically, have a perfectly circular shape.

When forming the grommet 30A, a first mold 80, which is an upper mold, and a second mold 90, which is a lower mold, are used (see FIG. 2, although not illustrated in detail). The first mold 80 and the second mold 90 are openable and closable with respect to each other. Here, the first mold 80 is constituted as a movable mold, and the second mold 90 is constituted as a fixed mold.

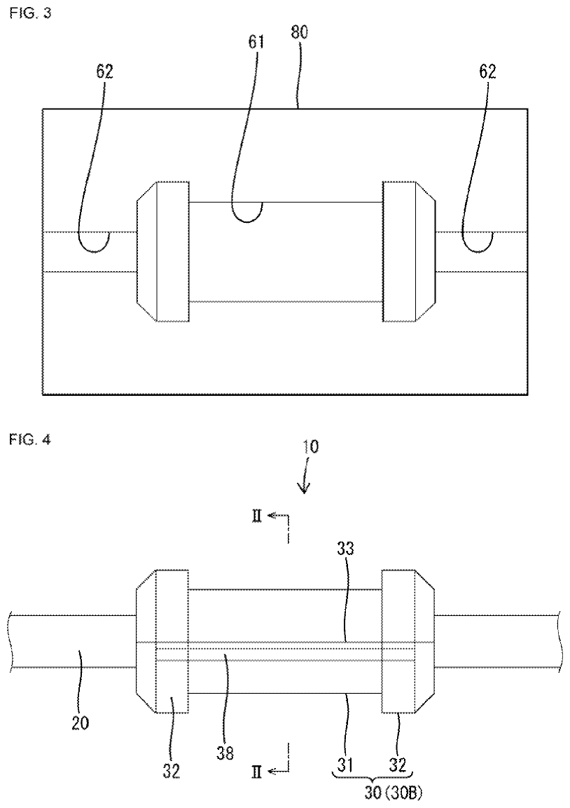

In a split surface 65 of each of the first mold 80 and the second mold 90, a grommet-forming cavity 61 and a wire through groove 62 are formed, as shown only for the first mold 80 in FIG. 3. The grommet-forming cavity 61 has a shape that corresponds to the outer peripheral shape of the grommet 30A, and is formed in the first mold 80 and the second mold 90 such that the transverse section thereof has a concave shape. The wire through groove 62 has a groove shape capable of holding the wire 20 on both axial sides with the grommet-forming cavity 61 sandwiched therebetween, and is similarly formed in the first mold 80 and the second mold 90 such that the transverse section thereof has a concave shape.

As shown in FIG. 1, the wiring member 10 has a parting line 33 extending axially. In the case of this first embodiment, the parting line 33 is installed in a position biased upward (to one side) of the center of the grommet 30A in the height direction (radial direction; release direction of first and second molds 80 and 90). Specifically, the parting line 33 is installed within the height range between the center of the wire 20 and the upper edge of the wire 20, so as to overlap with the wire 20 in the height direction, as shown in FIG. 2. The parting line 33 is provided in at two positions that correspond to the split surface 65 on the outer peripheral surface of the grommet 30A and are spaced apart in the circumferential direction of the outer peripheral surface of the grommet 30A.

As shown in FIG. 2, if the grommet 30A is divided in a virtual manner in the height direction into a first part 35 located upward and a second part 36 located downward, via a virtual plane 34 including the parting lines 33 located at two positions on the outer peripheral surface (virtual straight line connecting parting lines 33 located at two positions in transverse section), the outer peripheral length of the transverse section of the second part 36 is longer than the outer peripheral length of the transverse section of the first part 35. In the case of this first embodiment, the transverse section of the outer peripheral shape of the grommet 30A is circular, and thus the outer peripheral shape of the transverse section of the second part 36 is constituted as a major arc, and the outer peripheral shape of the transverse section of the first part 35 is constituted as a minor arc.

As described above, the outer peripheral surface of the second part 36 is constituted at an outer peripheral length that exceeds half the circumference of the grommet 30A. The two ends of the outer peripheral surface of the second part 36 are a pair of peripheral surface portions 37 that extend in an arc from the center of the grommet 30A in the height direction to the parting lines 33. Each peripheral surface portion 37 is formed in a direction that intersects the release direction of the first mold 80 and the second mold 90, and forms an undercut when the mold is opened. Therefore, the second part 36 has an undercut shape due to the peripheral surface portions 37.

On the other hand, the outer peripheral surface of the first part 35 is constituted at an outer peripheral length that is less than half the circumference of the grommet 30A. The first part 35 as a whole does not have an undercut shape that intersects the release direction of the first mold 80 and the second mold 90.

Next, a manufacturing method of the wiring member 10 will be described.

The wire 20 is placed in the wire through groove 62 of the second mold 90 with the first mold 80 and the second mold 90 in an open state, and the first mold 80 is closed with respect to the second mold 90. The wire 20 is held by the wire through grooves 62 of the first mold 80 and the second mold 90, and the grommet-forming cavity 61 is formed by being demarcated between the first mold 80 and the second mold 90. Next, a material (here, thermoplastic elastomer) in a molten state is injected into the grommet-forming cavity 61 through a gate (not shown). When the material hardens, the first mold 80 is opened and the wiring member 10 formed as a molded article is removed.

In the above description, the first part 35 of the grommet 30A is molded by the grommet-forming cavity 61 of the first mold 80. The second part 36 of the grommet 30A is molded by the grommet-forming cavity 61 of the second mold 90. The first part 35 does not have an undercut shape as a whole. Therefore, when the mold is opened, the first part 35 is easily released from the first mold 80. On the other hand, the second part 36 has an undercut shape due to the peripheral surface portions 37. Thus, when the mold is opened, the undercut peripheral surface portions 37 generate release resistance, and a state in which the second part 36 remains in the second mold 90 can be realized. As a result, the wiring member 10 formed as a molded article will always remain in the second mold 90, and the wiring member 10 can be easily removed from the second mold 90.

As described above, the wiring member 10 of this first embodiment is provided with the wire 20 and the molded part 30 covering the outer peripheral surface of the wire 20. The parting line 33 is provided at two positions on the outer peripheral surface of the molded part 30. If the molded part 30 is divided in a virtual manner into the first part 35 and the second part 36, via the virtual plane 34 including the parting lines 33 located at two positions, the first part 35 does not have an undercut shape with respect to the release direction orthogonal to the virtual plane 34, and the second part 36 has an undercut shape with respect to the release direction.

Because the first part 35 does not have an undercut shape with respect to the release direction and the second part 36 has an undercut shape with respect to the release direction, a state in which the first part 35 separates from the first mold 80 and the second part 36 remains in the second mold 90 can realized with certainty. As a result, the wiring member 10 formed as a molded article can be removed from the second mold 90 without difficulty, and an improvement in productivity can be achieved.

In the case of this first embodiment, the undercut shape is constituted by the peripheral surface portions 37 that extend in a direction intersecting the release direction on the outer peripheral surface of the second part 36. The undercut shape can thus be formed without providing the second part 36 with a special shape.

In particular, in the case of this first embodiment, the outer peripheral shape of the cross-section (transverse section) of the molded part 30 parallel to the release direction is circular, and the outer peripheral surface of the second part 36 has a major arc shape that includes the peripheral surface portions 37 and whose two circumferential ends are the parting lines 33 located at two positions. According to this configuration, the outer peripheral surface of the second part 36 does not include any special shape, and thus the wiring member 10 has a broader application range and can be provided with versatility.

The wiring member 10 of the present disclosure is constituted with the molded part 30 as the grommet 30A, and is thus able to suppress infiltration of water or the like between the wire 20 and the grommet 30A, and is suitably applicable in environments where, for example, waterproofness is required. Also, by applying the wiring member 10 to the wiring harness of an automobile, for example, an improvement in routing workability and usability can be achieved.

### SECOND EMBODIMENT

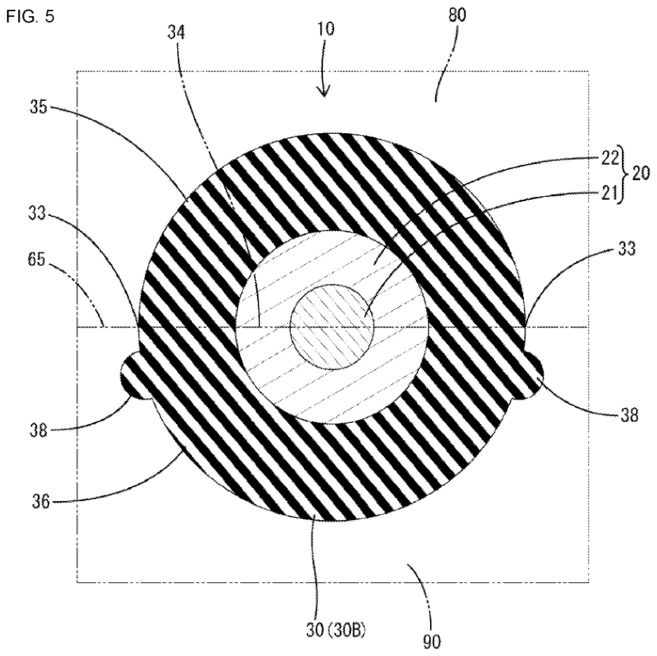

A wiring member 10 of a second embodiment of the present disclosure will be described using FIGS. 4 and 5. The wiring member 10 of this second embodiment differs from the above first embodiment in the position of the parting lines 33 and the undercut shape of the second part 36. The undercut shape of the second part 36 is constituted by a protrusion 38 that protrudes from the outer peripheral surface of the second part 36. The fact that the molded part 30 is a grommet 30B, and the grommet 30B has a main body 31 and a pair of wide diameter parts 32 is similar to the above first embodiment.

In the case of this second embodiment, the parting lines 33 are installed in the center of the grommet 30B in the height direction (radial direction; release direction of first and second molds 80 and 90). Specifically, the parting lines 33 are installed at the same height position as the center of the wire 20.

As shown in FIG. 5, if the grommet 30B is divided in a virtual manner in the height direction into a first part 35 located upward and a second part 36 located downward, via a virtual plane 34 including the parting lines 33 located at two positions on the outer peripheral surface, the first part 35 and the second part 36 are constituted as symmetrical half-bodies except for the protrusion 38 of the second part 36.

The protrusion 38 protrudes radially outward from the outer peripheral surface of the second part 36. In particular, the protrusion 38 protrudes in a direction that intersects the height direction, which is the release direction. The protrusion 38 is disposed as a pair downward of the parting lines 33 located at two positions, at the two circumferential end portions of the outer peripheral surface of the second part 36. The protrusions 38 are respectively disposed in close proximity to the parting lines 33 located at two positions. The outer peripheral shape of the transverse section of each protrusion 38 is arc-shaped. The outer peripheral shape of the transverse section of the second part 36 is arc-shaped (semicircular), except for the protrusions 38. As shown in FIG. 4, the protrusions 38 are formed in a rib shape extending axially. Here, the protrusions 38 are continuously formed on the outer peripheral surfaces of the main body 31 and the wide diameter parts 32.

When forming the grommet 30B, similarly to the above first embodiment, the first part 35 is molded by the grommet-forming cavity 61 of the first mold 80, and the second part 36 is molded by the grommet-forming cavity 61 of the second mold 90. The first part 35 does not have an undercut shape as a whole. Therefore, when the mold is opened, the first part 35 is easily released from the first mold 80. On the other hand, the second part 36 has an undercut shape due to the protrusions 38. Thus, when the mold is opened, the undercut protrusions 38 generate release resistance, and a state in which the second part 36 remains in the second mold 90 can be realized. As a result, the wiring member 10 formed as a molded article will always remain in the second mold 90, and the wiring member 10 can be easily removed from the second mold 90.

In the case of this second embodiment, the undercut shape is constituted by the protrusions 38 protruding from the outer peripheral surface of the second part 36, and thus release resistance of the second part 36 at the time of release can be set to an appropriate value by adjusting the shape, protruding dimension and angular position of the protrusions 38. In particular, because the protrusions 38 are disposed in close proximity to the parting lines 33, excessive release resistance during release of the second part 36 caused by the protrusions 38 can be avoided.

### THIRD EMBODIMENT

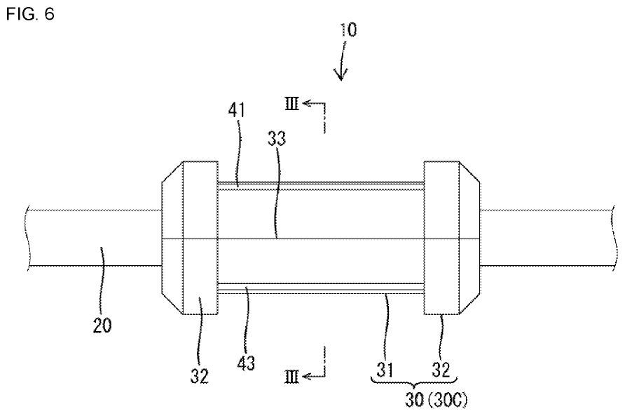

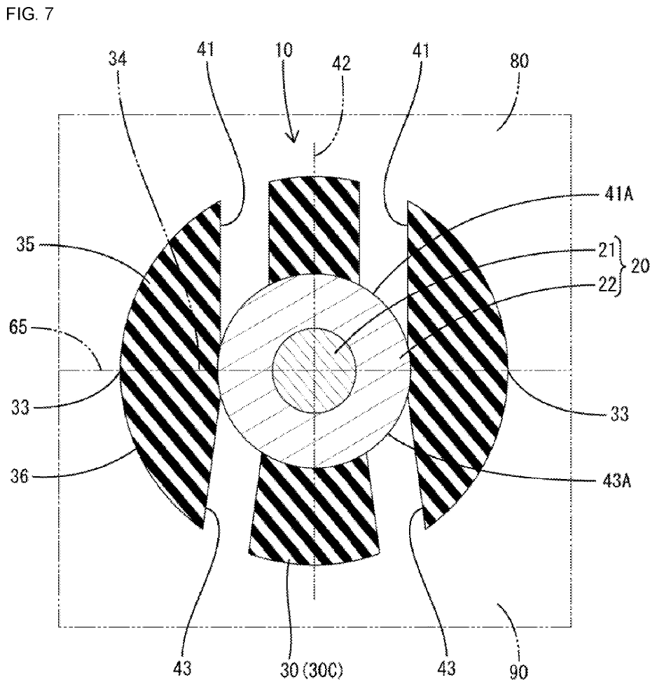

A wiring member 10 of a third embodiment of the present disclosure will be described using FIGS. 6 and 7. The wiring member 10 of this third embodiment differs from the above first embodiment in the position of the parting lines 33 and the shapes of the first part 35 and the second part 36. The fact that the molded part 30 is a grommet 30C and the grommet 30C has a main body 31 and a pair of wide diameter parts 32 is similar to the above first embodiment.

In the case of this third embodiment, the parting lines 33 are installed in the center of the grommet 30C in the height direction (radial direction; release direction of first and second molds 80 and 90), when the wiring member 10 is viewed from the side. Specifically, the parting lines 33 are installed at the same height position as the center of the wire 20.

If the grommet 30C is divided in a virtual manner in the height direction into a first part 35 located upward and a second part 36 located downward, via a virtual plane 34 including the parting lines 33 located at two positions on the outer peripheral surface, the first part 35 and the second part 36 are constituted as asymmetrical shapes to each other.

As shown in FIG. 7, the first part 35 has a non-undercut recess 41 that extends in the height direction, which is the release direction, through the inside of the first part 35. The non-undercut recess 41 is disposed as a pair on the left and right sides with a virtual symmetrical axis 42 that passes through the center of the wire 20 orthogonal to the virtual plane 34 sandwiched therebetween. The upper edge of each non-undercut recess 41 is open on the outer peripheral surface of the first part 35. The lower end of each non-undercut recess 41 is blocked by the outer peripheral surface of the wire 20. In other words, the non-undercut recesses 41 each have the outer peripheral surface of the wire 20 as a bottom surface 41A (innermost surface). The outer peripheral shape of the transverse section of the first part 35 is arc-shaped (semicircular) except for the openings of the non-undercut recesses 41. Since the non-undercut recesses 41 are formed in the release direction, the first part 35 does not have an undercut shape. As shown in FIG. 6, the non-undercut recesses 41 are formed as slit grooves extending axially. Here, the non-undercut recesses 41 are formed over the entire axial length of the main body 31.

As shown in FIG. 7, the second part 36 has an undercut recess 43 that extends in a direction intersecting the height direction, which is the release direction, through the inside of the second part 36. The undercut recess 43 is disposed as a pair on the left and right sides with the virtual symmetrical axis 42 sandwiched therebetween. The lower edge of each undercut recess 43 is open on the outer peripheral surface of the second part 36. The upper edge of each undercut recess 43 is blocked by the outer peripheral surface of the wire 20. In other words, the undercut recesses 43 each have the outer peripheral surface of the wire 20 as a bottom surface 43A (innermost surface). The undercut recesses 43 widen toward the openings on the outer peripheral surface from the bottom surfaces 43A so as move apart from each other. The outer peripheral shape of the transverse section of the second part 36 is arc-shaped (semicircular) except for the openings of the undercut recesses 43. Since the undercut recesses 43 are formed in a direction that intersects the release direction, the second part 36 has an undercut shape. As shown in FIG. 6, the undercut recesses 43 are formed as slit grooves that extend axially. Here, the undercut recesses 43 are formed over the entire axial length of the main body 31.

In this third embodiment, when forming the grommet 30C, a pressing mold (not shown) that presses down the wire 20 is used, in addition to the first mold 80 which is the upper mold and the second mold 90 which is the lower mold. The pressing molds are disposed to be slidable with respect to the first mold 80 and the second mold 90. The pressing molds have a shape that corresponds to positions respectively corresponding to the non-undercut recesses 41 and the undercut recesses 43.

In a state where the first mold 80 and the second mold 90 are closed and the grommet-forming cavity 61 is formed inside thereof, the wire 20, which is an insert component, is held by the pressing molds. When the grommet-forming cavity 61 is filled with a molten material, variation of the wire 20 is suppressed by the pressing molds. When the first mold 80 is opened with respect to the second mold 90, the first part 35 is easily released from the first mold 80, because the pressing molds in the first mold 80 are disposed in the release direction so as to correspond to the non-undercut recesses 41. On the other hand, the pressing molds in the second mold 90 are disposed in a direction intersecting the release direction so as to correspond to the undercut recesses 43, and thus a state in which the second part 36 remains in the second mold 90 can be realized with certainty. Thereafter, the pressing molds in the second mold 90 are extracted, and the wiring member 10 formed as a molded article is removed from the second mold 90. The non-undercut recesses 41 and the undercut recesses 43 are formed due to the extraction of the pressing molds.

In the case of this third embodiment, the undercut shape is constituted by the undercut recesses 43 that extend in a direction intersecting the release direction inside the second part 36 and open on the outer peripheral surface of the second part 36, and thus the outer peripheral shape of the second part 36 and, hence, the wiring member 10 can be prevented from increasing in size.

Also, in the case of this third embodiment, the grommet 30C has the non-undercut recesses 41 that extend in the release direction inside the first part 35 and open on the outer peripheral surface of the first part 35. The bottom surfaces 41A and 43A of the undercut recesses 43 and the non-undercut recesses 41 are constituted by the outer peripheral surface of the wire 20. The undercut recesses 43 and the non-undercut recesses 41 are formed due to the extraction of the pressing molds for pressing down the wire 20. The undercut recesses 43 and the non-undercut recesses 41 are thus obtained without requiring dedicated parts that merely constitute undercut shapes and non-undercut shapes.

### OTHER EMBODIMENTS OF THE DISCLOSURE

The above first to third embodiments disclosed herein are to be considered in all respects as illustrative and not restrictive.

In the case of the above first to third embodiments, the outer peripheral shape of the transverse section of the wiring member is circular. Alternatively, the outer peripheral shape of the transverse section of the wiring member may be non-circular, including a polygonal shape such as a square. A flat wire or the like whose outer peripheral shape in transverse section is non-circular can also be used as the wire.

In the case of the above first to third embodiments, the molded part is a grommet. Alternatively, according to another embodiment, the molded part is not limited to a grommet and may be a non-elastically deformable resin molded part, for example.

In the case of the above third embodiment, the bottom surfaces of the undercut recesses and the non-undercut recesses are constituted by the outer peripheral surface of the wire. Alternatively, according to another embodiment, the bottom surfaces of the undercut recesses and non-undercut recesses may be blocked inside the molded part before reaching the outer peripheral surface of the wire. Also, a configuration can be adopted in which the molded part is only provided with undercut recesses and is not provided with non-undercut recesses.

In the case of the above third embodiment, openings for the undercut recesses and the non-undercut recesses are formed in the outer peripheral surface of the molded part. Alternatively, according to another embodiment, an attachment member may be attached to the outer peripheral surface of the molded part, and the openings of the undercut recesses and non-undercut recesses may be blocked by the attachment member. For example, tape serving as the attachment member may be wrapped around the outer peripheral surface of the molded part and the openings of the undercut recesses and the non-undercut recesses may be blocked with the tape. Also, a clip or the like that is fixed to the vehicle or the like may be used as the attachment member.

What is claimed is:

1. A wiring member comprising:
a wire; and
a molded part covering an outer peripheral surface of the wire,
wherein a parting line is provided at two positions on an outer peripheral surface of the molded part, and
if the molded part is divided in a virtual manner into a first part and a second part, via a virtual plane including the parting lines located at two positions, the first part does not have an undercut shape with respect to a release direction orthogonal to the virtual plane, and the second part has an undercut shape with respect to the release direction.

2. The wiring member according to claim 1, wherein the undercut shape is constituted by a peripheral surface portion extending in a direction intersecting the release direction on an outer peripheral surface of the second part.

3. The wiring member according to claim 2, wherein an outer peripheral shape of a cross-section of the molded part parallel to the release direction is circular, and
the outer peripheral surface of the second part has a major arc shape including the peripheral surface portion and whose two circumferential ends are the parting lines located at two positions.

4. The wiring member according to claim 1, wherein the undercut shape is constituted by a protrusion protruding from an outer peripheral surface of the second part in a direction intersecting the release direction.

5. The wiring members according to claim 4, wherein the protrusion is disposed in close proximity to each of the parting lines.

6. The wiring member according to claim 1, wherein the undercut shape is constituted by an undercut recess extending in a direction intersecting the release direction inside the second part and opening on an outer peripheral surface of the second part.

7. The wiring member according to claim 6, wherein the molded part has a non-undercut recess extending in the release direction inside the first part and opening on an outer peripheral surface of the first part, and
a bottom surface of each of the undercut recess and the non-undercut recess is constituted by the outer peripheral surface of the wire.

8. The wiring member according to claim 1, wherein the molded part is a grommet.
